(19) United States
(12) Patent Application Publication
(10) Pub. No.: US 2015/0358182 A1
(43) Pub. Date: Dec. 10, 2015

(54) CHANNEL ESTIMATION METHOD AND ASSOCIATED DEVICE FOR ESTIMATING CHANNEL FOR OFDM SYSTEM

(71) Applicant: MediaTek Singapore Pte. Ltd., Singapore (SG)

(72) Inventors: Hengsheng Tang, Beijing (CN); Songsong Sun, Tustin, CA (US)

(21) Appl. No.: 14/298,956

(22) Filed: Jun. 8, 2014

(51) Int. Cl. H04L 25/02; H04L 5/00

(52) U.S. Cl. CPC H04L 25/0224; H04L 5/0007; H04L 5/0048; H04L 25/0204

(57) ABSTRACT

A channel estimation method and an associated device for estimating a data channel of a data resource element are provided. The channel estimation method includes obtaining a plurality of pilot channels for pilot resource elements in a time-frequency domain, respectively; utilizing a processing circuit to apply a transformation matrix to the pilot channels, to obtain a plurality of transformed pilot channels corresponding to the pilot resource elements, respectively; and estimating the data channel of the data resource element by performing a plurality of one-dimensional channel estimations according to the transformed pilot channels.

### BACKGROUND

The present invention relates to a channel estimation method, and more particularly, to a channel estimation method and associated device for estimating both the pilot channel and data channel of data resource element.

In communication systems such as the third Generation Partnership Project (3GPP) Long Term Evolution (LTE) (hereinafter “LTE”), variations in phase and amplitude are introduced into signals transmitted along the channel. These variations can be realized as channel response. The channel response is usually frequency-dependent and time-dependent. If the receiver can correctly detect the channel response, channel degradation in the received signal can be compensated. Detection of the channel response is called channel estimation. In the LTE system, a number of resource elements (REs) are chosen to carry pilot signals for channel estimation purposes. The pilot signals contain useful information which facilitates the channel estimator in order to detect the channel response of a specific frequency and time. These resource elements carrying the pilot signals are also called pilot resource elements.

Due to heavy data traffic involved in wireless communication techniques, how to effectively estimate data channels of the data resource elements has become an important issue. Estimating the data channels of data resource elements is important for the recovery of the transmitted information data at the receiver to thereby reach high receiving quality. There is usually a tradeoff between hardware complexity and the channel estimation accuracy, however. For example, in the LTE system, pilot channels are already defined in the specification, and therefore the channel estimation schemes of the receiver must be designed to take advantage of available pilot channels as much as possible. Although the accuracy of the estimation results of some traditional channel estimation techniques is acceptable, the hardware scheme of these techniques may be too complex to be implemented, or may raise the cost significantly.

Please refer to FIG. 1, which is a diagram illustrating a prior art channel estimation method performed upon a time-frequency domain 100, wherein the x-axis represents the time domain, and the y-axis represents the frequency domain. As shown in FIG. 1, the time-frequency domain 100 includes a plurality of pilot resource elements represented by the time-frequency grids H0-H17 aligned in both the time direction and the frequency direction. The pilot resource elements H0-H17 are utilized to estimate the data channel of the data resource element (i.e. the grid RE1) by performing a two-dimensional (2D) channel estimation, wherein the data resource element RE1 is calculated by interpolating all of the pilot channels H0-H17. Although the above operation may improve the performance of the channel estimation, a relatively large ROM/RAM size is required. For example, each data resource element is estimated by performing a plurality of multiplication operations (18 multiplication operations are required for estimating each data resource element), which thereby increases the computational complexity thereof.

There is a need for a novel channel estimation method that can improve the channel estimation performance without significantly raising the cost.

### SUMMARY

An object of the present invention is to provide a channel estimation method and an associated device to solve the aforementioned problem.

Another object of the present invention is to provide a channel estimation method and an associated device for performing channel estimations with low computational complexity and a small ROM/RAM size.

An embodiment of the present invention provides a channel estimation method arranged for estimating a data channel of a data resource element. The channel estimation method comprises obtaining a plurality of pilot channels for pilot resource elements in a time-frequency domain, respectively; utilizing a processing circuit to apply a transformation matrix to the pilot channels, to obtain a plurality of transformed pilot channels corresponding to the pilot resource elements, respectively; and estimating the data channel of the data resource element by performing a plurality of one-dimensional channel estimations according to the transformed pilot channels.

Another embodiment of the present invention provides a channel estimation device arranged for estimating a data channel of a data resource element. The channel estimation device comprises a pilot channel estimator, a processing circuit and a data channel estimator. The pilot channel estimator is arranged to obtain a plurality of pilot channels for pilot resource elements in a time-frequency domain, respectively. The processing circuit is arranged to apply a transformation matrix to the pilot channels, to obtain a plurality of transformed pilot channels corresponding to the pilot resource elements, respectively. The data channel estimator is arranged to estimate the data channel of the data resource element by performing a plurality of one-dimensional channel estimations according to the transformed pilot channels.

Another embodiment of the present invention provides a channel estimation method for estimating a data channel of a data resource element (RE). The channel estimation method comprises: obtaining a plurality of pilot channels for pilot resource elements in a time-frequency domain, respectively; utilizing a processing circuit to use the plurality of pilot channels for pilot resource elements to obtain a plurality of reference channels corresponding to the pilot resource elements, respectively; and estimating the data channel of the data resource element by performing a one-dimensional (1D) channel estimations according to the reference pilot channels.

Another embodiment of the present invention provides a channel estimation device arranged for estimating a data channel of a data resource element (RE). The channel estimation device comprises a pilot channel estimator, a processing circuit and a data channel estimator. The pilot channel estimator is arranged to obtain a plurality of pilot channels for pilot resource elements in a time-frequency domain, respectively. The processing circuit is arranged to use the plurality of pilot channels for pilot resource elements to obtain a plurality of reference channels corresponding to the pilot resource elements, respectively. The data channel estimator, arranged to estimate the data channel of the data resource element by performing a one-dimensional (1D) channel estimations according to the reference pilot channels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art channel estimation method performed upon a time-frequency domain.

FIG. 2 is a diagram illustrating a channel estimation device arranged for estimating a data channel of a data resource element.

FIG. 3 is a diagram illustrating a scenario of performing channel estimation upon the time-frequency domain shown in FIG. 1 according to an embodiment of the present invention.

FIG. 4 is a diagram illustrating a scenario of performing channel estimation upon the time-frequency domain shown in FIG. 1 according to another embodiment of the present invention.

FIG. 5 is a flowchart illustrating a channel estimation method according to an embodiment of the present invention.

FIG. 6 is a diagram illustrating a scenario of performing channel estimation upon the time-frequency domain shown in FIG. 1 according to yet another embodiment of the present invention.

FIG. 7 is a diagram illustrating a scenario of performing channel estimation upon the time-frequency domain shown in FIG. 1 according to still another embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

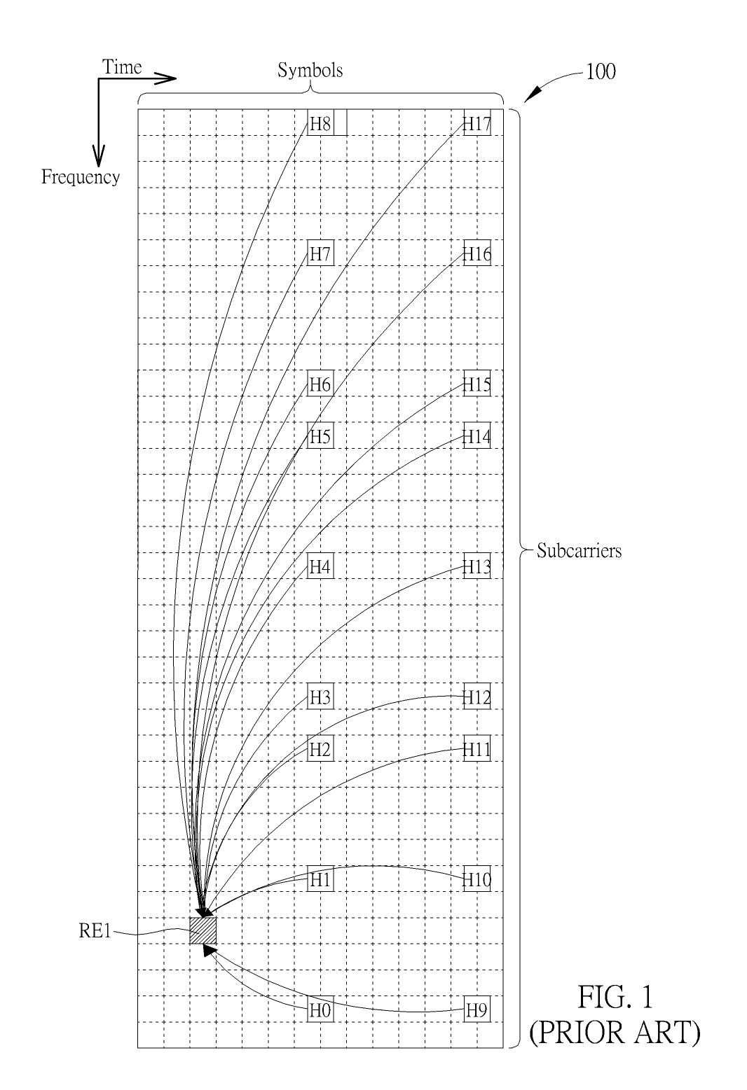

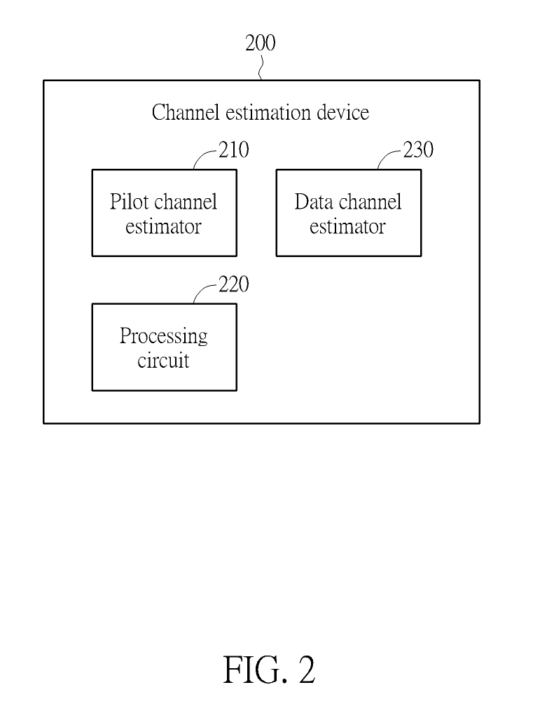

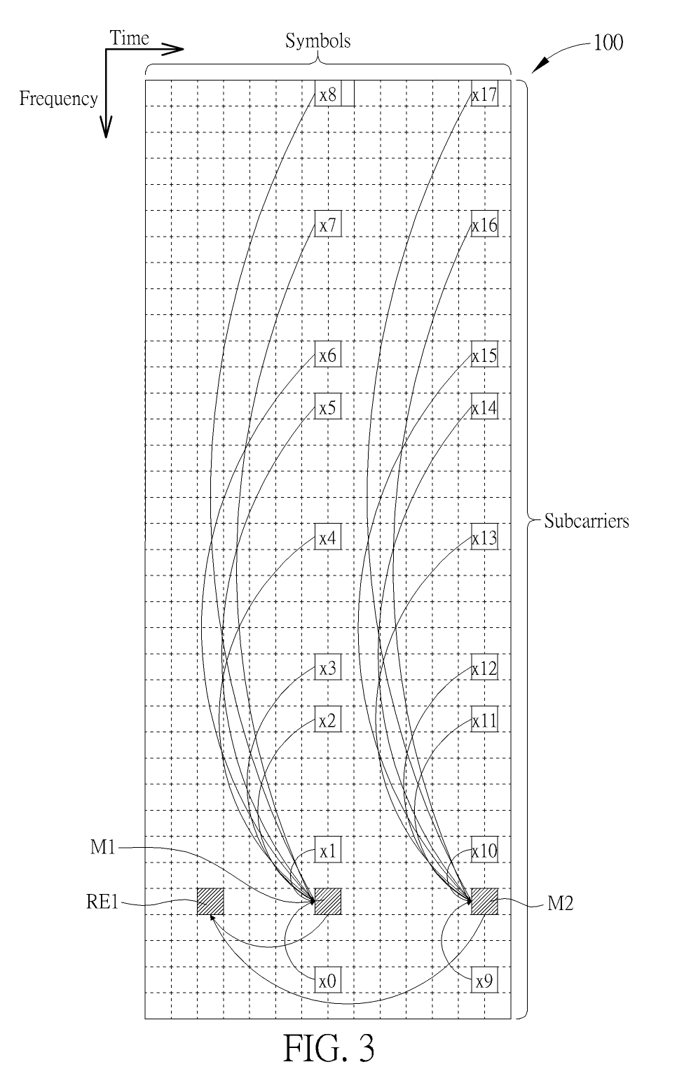

Please refer to FIG. 2, which is a diagram illustrating a channel estimation device 200 arranged for estimating a data channel of a data resource element. FIG. 3 is a diagram illustrating a scenario of performing channel estimation upon the time-frequency domain 100 shown in FIG. 1 according to an embodiment of the present invention. As shown in FIG. 2, the channel estimation device 200 includes a pilot channel estimator 210, a processing circuit 220 and a data channel estimator 230. The pilot channel estimator 210 is arranged to obtain a plurality of pilot channels for pilot resource elements (e.g. the pilot channels H0-H17 as shown in FIG. 1) in the time-frequency domain 100, respectively. After the pilot channels H0-H17 are obtained, the data resource element RE1 may be estimated accordingly. Please note the above is for illustrative purposes; the present invention is not limited to the pattern, and the number of the pilot channels is also not limited.

Please note that the pilot channel estimation accuracy can be enhanced with the assistance of other pilots, since the original pilot channel is raw generally derived by a least square estimator for each pilot resource element independently.

The processing circuit 220 is arranged to apply a transformation matrix T to the pilot channels H0-H17, for obtaining a plurality of transformed pilot channels x0-x17 corresponding to the pilot channels H0-H17, respectively. For example, each of the pilot channels H0-H17 may be stacked as a vector h′. The vector h′ can be expressed by the following equation (1), wherein h represents the ideal pilot channel vector, and η represents the noise vector.

h′=h+η (1)

Then, the transformed vector x is obtained through utilizing the transformation matrix T as the following equation (2):

x=T·h′

After obtaining the transformed vector x for each pilot channel, a minimum mean-square error (MMSE) interpolation may be utilized to mitigate the influence of the noise vector η and improve the performance of the channel estimation. Please note that the transformation matrix can be some classical transformation matrices, some coefficient matrices, or an identity matrix. The present invention does not limit the type of transformation matrix. Further, the MMSE interpolation may be replaced with other mathematical computations (e.g. the least-square (LS) estimation, linear interpolation and averaging operation) as long as similar results can be achieved. The present invention is not limited to the MMSE interpolation.

The data channel estimator 230 is arranged to estimate the data channel of the data resource element by performing a plurality of one-dimensional (1D) channel estimations according to the transformed pilot channels x0-x17. More specifically, the 1D channel estimations include a first interpolation operation in a first direction and a second interpolation operation in a second direction, wherein the second interpolation operation is performed after the first interpolation operation. In this embodiment, the first direction is the time direction, and the second direction is the frequency direction. This is merely for illustrative purposes, however. In some modifications of this embodiment, the first direction may be the frequency direction, and the second direction may be the time direction. In short, the 1D channel estimation will be performed once for each of the time and frequency domains.

The transformed pilot channels x0-x8 of the same symbol may be utilized (e.g. interpolated or multiplied) to generate a temporary pilot channel M1 on the subcarrier where the data resource element RE1 is located. Similarly, the transformed pilot channels x9-x17 of the same symbol may be utilized (e.g. interpolated or multiplied) to generate another temporary pilot channel M2 on the subcarrier where the data resource element RE1 and the temporary pilot channel M1 are located. Next, the temporary pilot channels M1 and M2 may be interpolated to generate the estimated data channel of the data resource element RE1. The data channel of the data resource element RE1 may be estimated by performing 1D channel estimations twice according to the transformed pilot channels x0-x17.

The whole channel estimation operation is performed with two 1D channel estimation operations instead of the 2D channel estimation operation of the conventional method illustrated in FIG. 1. The computational complexity is therefore greatly reduced. Since the pilot channels H0-H17 are further transformed into the transformed pilot channels x0-x17, the detected noise can be mitigated by applying the MMSE interpolation, and the channel estimation performance is improved.

More specifically, the temporary pilot channel M1 requires performing 9 multiplications with the transformed pilot channels x0-x8 to be generated. Similarly, the temporary pilot channel M2 requires performing 9 multiplications with the transformed pilot channels x9-x17 to be generated. The data resource element RE1 requires performing 2 multiplications with the temporary pilot channels M1-M2 to be generated. If neglecting the complexity for calculating x, the first data resource element RE1 requires a total of 20 multiplications, the following estimation upon each of the data resource elements on the same subcarrier (column) where the data resource element RE1 is located requires only 2 multiplications, since x and the time (frequency) direction interpolation results can be reused. The estimations upon each of the data resource elements on the same subcarrier where the data resource element RE1 is located therefore require about 3.3 multiplications on average. The aforementioned conventional 2D channel estimation method, however, requires 18 multiplication operations on average for each of data resource element. Hence, the embodiment of the present invention is capable of reducing the computational complexity, and thereby reducing the hardware loading.

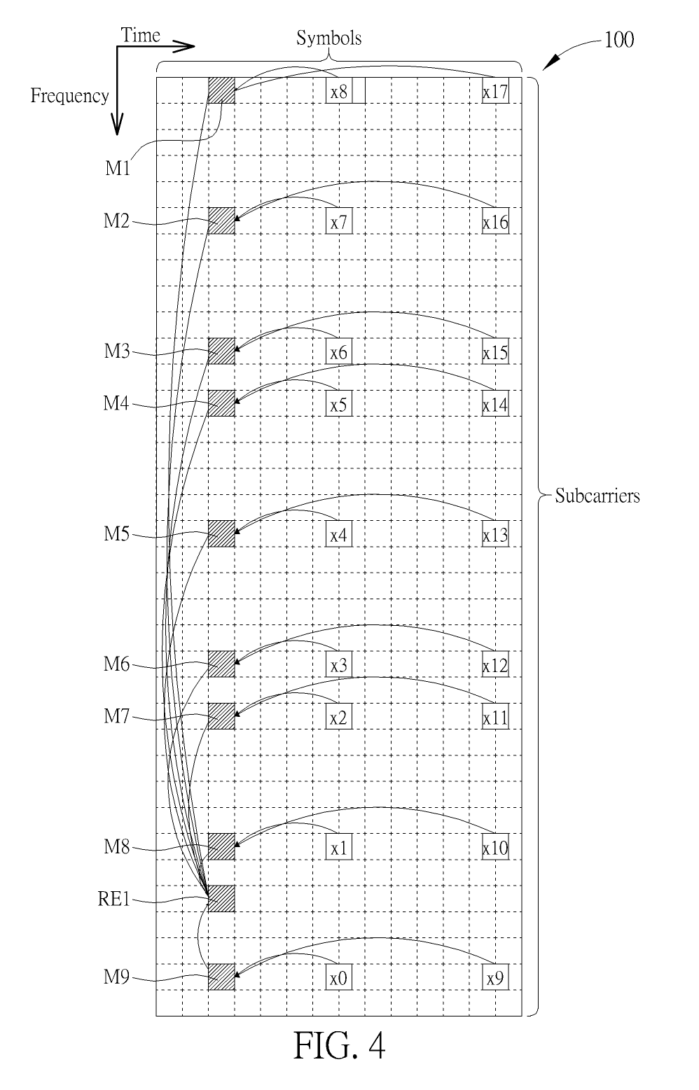

Further, this embodiment can be implemented with two steps. The first step is to perform channel estimation for the reference resource elements (e.g. temporary pilot channels M1 and M2), so as to use the calculated reference resource elements to estimate the data resource element (e.g. the data resource element RE1). The second step is to reuse the calculated reference resource elements to calculate other data resource elements on the same subcarrier where the first data resource element (e.g. the data resource element RE1) is located. That is, a one-dimensional interpolation is performed with the help of reference resource elements to obtain a next data resource element, thus reducing the computational complexity. Hence, when calculating the channel for REs in the same subcarrier, the x does not need to be recalculated. Besides, the first direction interpolation results do not need to be re-calculated as well. Please refer to FIG. 4, which is a diagram illustrating a scenario of performing channel estimation upon the time-frequency domain 100 shown in FIG. 1 according to another embodiment of the present invention. In this embodiment, the frequency directional interpolation operation is performed first. For example, the transformed pilot channels x8 and x17 of the same subcarrier may be utilized (e.g. interpolated or multiplied) to generate a temporary pilot channel M1 on the symbol where the data resource element RE1 is located, and the transformed pilot channels x7 and x16 of the same subcarrier may be utilized (e.g. interpolated or multiplied) to generate another temporary pilot channel M2 on the symbol where the data resource element RE1 and the temporary pilot channel M1 are located. After the temporary pilot channels M1-M9 are generated, the temporary pilot channels M1-M9 may be interpolated to generate the estimated data channel of the data resource element RE1. In other words, the data channel of the data resource element RE1 may be estimated by performing a plurality of 1D channel estimations according to the transformed pilot channels x0-x17.

This embodiment is also capable of improving the channel estimation performance without increasing the computational complexity, and thereby reducing the hardware loading. Compared with the conventional channel estimation method, this embodiment requires less multiplication operations to obtain the precise channel estimation result.

Similarly, this embodiment can be implemented with two steps. The first step is to perform channel estimation for the reference resource elements (e.g. temporary pilot channels M1-M9), so as to use the calculated reference resource elements to estimate the data resource element (e.g. the data resource element RE1). The second step is to reuse the calculated reference resource elements to calculate other data resource elements on the same symbol where the first data resource element (e.g. the data resource element RE1) is located. That is, a one-dimensional interpolation is performed with the help of reference resource elements to obtain a next data resource element, thus reducing the computational complexity. Hence, when calculating the channel for REs in the same symbol, the y does not need to be recalculated. Besides, the first direction interpolation results do not need to be re-calculated as well.

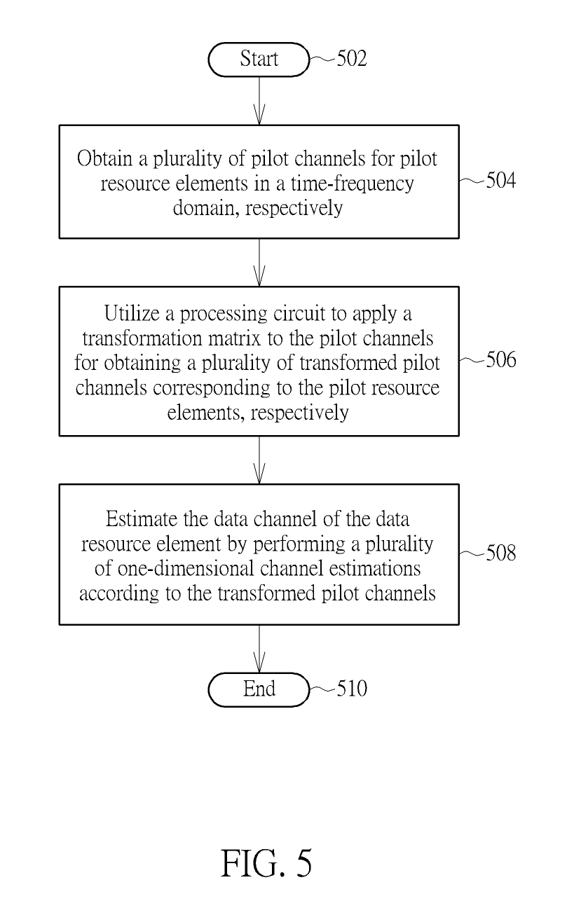

Please refer to FIG. 5, which is a flowchart illustrating a channel estimation method according to an embodiment of the present invention. Please note that, if the result is substantially the same, the steps are not required to be executed in the exact order shown in FIG. 5. The flowchart can be briefly summarized as follows.

Step 502: Start.

Step 504: Obtain a plurality of pilot channels for pilot resource elements in a time-frequency domain, respectively.

Step 506: Utilize a processing circuit to apply a transformation matrix to the pilot channels for obtaining a plurality of transformed pilot channels corresponding to the pilot resource elements, respectively.

Step 508: Estimate the data channel of the data resource element by performing a plurality of one-dimensional channel estimations according to the transformed pilot channels.

Step 510: End.

As one skilled in the art can readily understand details of each step shown in FIG. 5 after reading the above paragraphs directed to the channel estimation device 200, further description is omitted here for brevity.

Please note that the pilot channel estimation accuracy can be enhanced as well with the assistance of other pilots, since the aforementioned pilot channels are considered as raw data that may be jointly utilized to obtain the desired RE1.

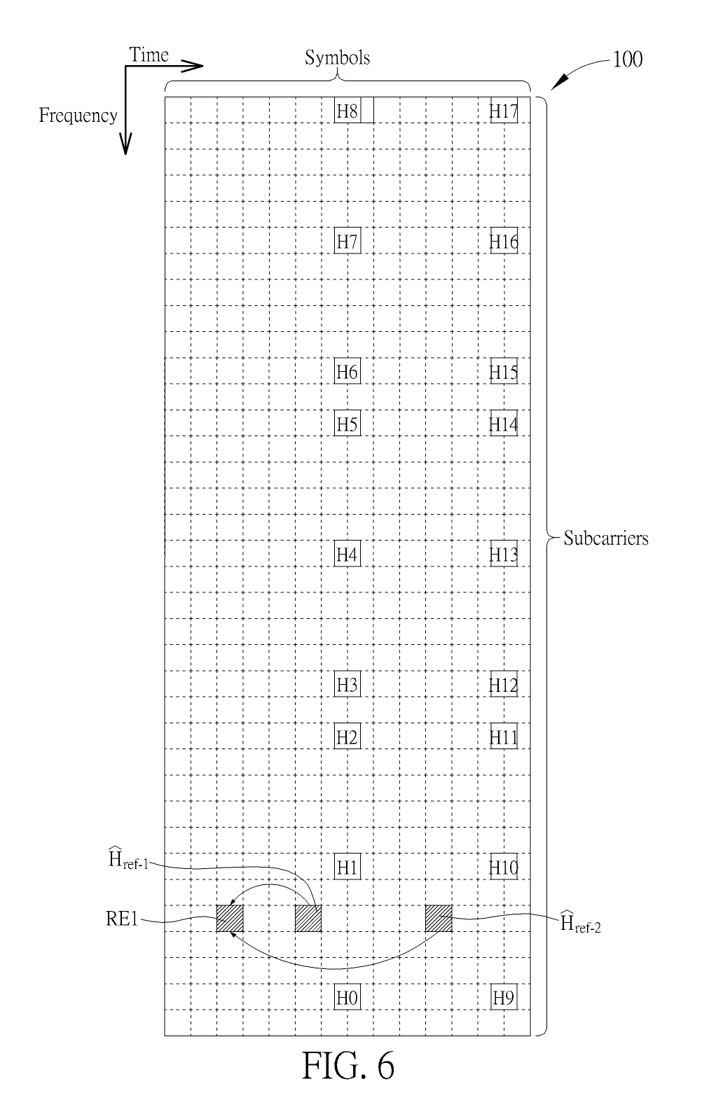

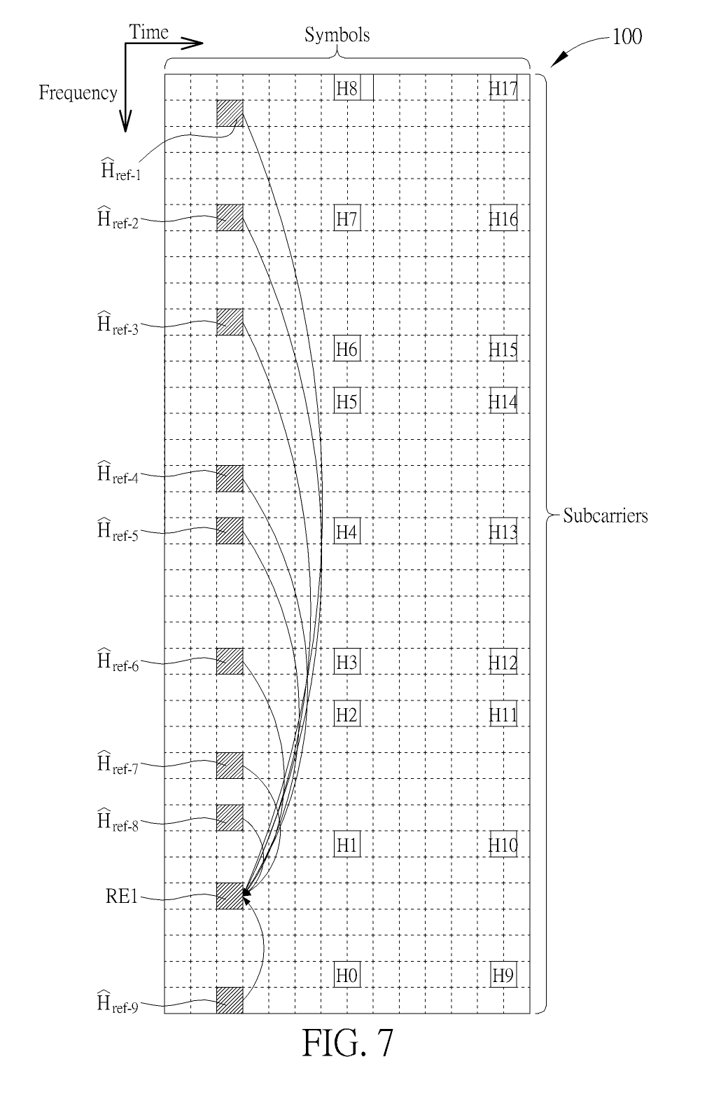

Please refer to FIGS. 6 and 7. FIG. 6 is a diagram illustrating a scenario of performing channel estimation upon the time-frequency domain shown in FIG. 1 according to yet another embodiment of the present invention, and FIG. 7 is a diagram illustrating a scenario of performing channel estimation upon the time-frequency domain shown in FIG. 1 according to still another embodiment of the present invention. The entire channel estimation can be divide into two steps: Step-1: Utilize a processing circuit of a channel estimation device to estimate the channels (such as Ĥ_{ref-1} and Ĥ_{ref-2} in FIG. 6 or Ĥ₁˜Ĥ_{ref-9} in FIG. 7, but not the intermediate calculation results M1, M2, . . . shown in the FIGS. 3-4) for reference REs in the same subcarrier or same symbol as the desired RE1; and

Step-2: Interpolate the channel for the desired RE with the assistance of the reference REs.

For example, in FIG. 6, the pilot channels H0, H1 and H2 may be jointly utilized to obtain the reference channel Ĥ_{ref-1}, and the pilot channels H9, H10 and H11 may be jointly utilized to obtain the reference channel Ĥ_{ref-2}. However, the present invention is not limited thereto. In a modification, the reference channel Ĥ_{ref-2} may be obtained by jointly utilizing the pilot channels H0, H1, H9 and H10, or even all pilot channels.

In other words, the exemplary scenario in FIG. 6 estimates channels Ĥ_{ref-1} and Ĥ_{ref-2} for reference REs in the same subcarrier, and then interpolate the reference REs to obtain the desired RE1, and the exemplary scenario in FIG. 7 estimates channels Ĥ_{ref-1}˜Ĥ_{ref-9} for reference REs in the same symbol, and then interpolate the reference REs to obtain the desired RE1. Please note that, the reference REs do not necessarily to be aligned with pilot RE's. Besides, the reference RE number could be equal to/less than/greater than the pilot RE number in the same subcarrier (or symbol).

Besides, the aforementioned transformation matrix T may be applied to the exemplary embodiment shown in FIGS. 6 and 7, to obtain the reference channel estimation results. Since similar schemes are introduced in the embodiments of FIGS. 3 and 4, the detailed descriptions are omitted here for brevity.

To summarize, the present invention is capable of improving the channel estimation performance with low computational complexity, thereby solving the problems of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A channel estimation method for estimating a data channel of a data resource element (RE), comprising:
obtaining a plurality of pilot channels for pilot resource elements in a time-frequency domain, respectively;
utilizing a processing circuit to apply a transformation matrix to the pilot channels, to obtain a plurality of transformed pilot channels corresponding to the pilot resource elements, respectively; and
estimating the data channel of the data resource element by performing a plurality of one-dimensional (1D) channel estimations according to the transformed pilot channels.

2. The channel estimation method of claim 1, wherein the 1D channel estimations includes a first interpolation operation in a first direction and a second interpolation operation in a second direction; one of the first direction and the second direction is a time direction of the time-frequency domain, and the other of the first direction and the second direction is a frequency direction of the time-frequency domain; and the step of estimating the data channel of the data resource element comprises:
performing the first interpolation operation in the first direction based on the transformed pilot channels, to generate a plurality of interpolated data channels; and
performing the second interpolation operation in the second direction based on the interpolated data channels, to generate the data channel of the data resource element.

3. The channel estimation method of claim 2, further comprising:
reusing the interpolated data channels to perform the second interpolation operation in the second direction, to generate a data channel of another data resource element, wherein the other data resource element and the data resource element are on a same axis of the second direction.

4. The channel estimation method of claim 2, wherein the first direction is the time direction, and the second direction is the frequency direction.

5. The channel estimation method of claim 2, wherein the first direction is the frequency direction, and the second direction is the time direction.

6. A channel estimation device, arranged for estimating a data channel of a data resource element (RE), the channel estimation device comprising:
a pilot channel estimator, arranged to obtain a plurality of pilot channels for pilot resource elements in a time-frequency domain, respectively;
a processing circuit, arranged to apply a transformation matrix to the pilot channels, to obtain a plurality of transformed pilot channels corresponding to the pilot resource elements, respectively; and
a data channel estimator, arranged to estimate the data channel of the data resource element by performing a plurality of one-dimensional (1D) channel estimations according to the transformed pilot channels.

7. The channel estimation device of claim 6, wherein the 1D channel estimations includes a first interpolation operation in a first direction and a second interpolation operation in a second direction; one of the first direction and the second direction is a time direction of the time-frequency domain, and the other of the first direction and the second direction is a frequency direction of the time-frequency domain; the data channel estimator is used to perform the first interpolation operation in the first direction based on the transformed pilot channels to generate a plurality of interpolated data channels, and perform the second interpolation operation in the second direction based on the interpolated data channels to generate the data channel of the data resource element.

8. The channel estimation device of claim 7, wherein the interpolated data channels are reused to perform the second interpolation operation in the second direction, to generate a data channel of another data resource element; and the other data resource element and the data resource element are on a same axis of the second direction.

9. The channel estimation device of claim 7, wherein the first direction is the time direction, and the second direction is the frequency direction.

10. The channel estimation device of claim 7, wherein the first direction is the frequency direction, and the second direction is the time direction.

11. A channel estimation method for estimating a data channel of a data resource element (RE), comprising:
obtaining a plurality of pilot channels for pilot resource elements in a time-frequency domain, respectively;
utilizing a processing circuit to use the plurality of pilot channels for pilot resource elements to obtain a plurality of reference channels corresponding to the pilot resource elements, respectively; and
estimating the data channel of the data resource element by performing a one-dimensional (1D) channel estimations according to the reference pilot channels.

12. The channel estimation method of claim 11, wherein the 1D channel estimation is a time direction interpolation.

13. The channel estimation method of claim 12, wherein the reference pilot channels and the data resource element are on a same axis of the time direction.

14. The channel estimation method of claim 11, wherein the 1D channel estimation is a frequency direction interpolation.

15. The channel estimation method of claim 14, wherein the reference pilot channels and the data resource element are on a same axis of the frequency direction.

16. A channel estimation device, arranged for estimating a data channel of a data resource element (RE), the channel estimation device comprising:
a pilot channel estimator, arranged to obtain a plurality of pilot channels for pilot resource elements in a time-frequency domain, respectively;
a processing circuit, arranged to use the plurality of pilot channels for pilot resource elements to obtain a plurality of reference channels corresponding to the pilot resource elements, respectively; and
a data channel estimator, arranged to estimate the data channel of the data resource element by performing a one-dimensional (1D) channel estimations according to the reference pilot channels.

17. The channel estimation device of claim 16, wherein the 1D channel estimation is a time direction interpolation.

18. The channel estimation device of claim 17, wherein the reference pilot channels and the data resource element are on a same axis of the time direction.

19. The channel estimation device of claim 16, wherein the 1D channel estimation is a frequency direction interpolation.

20. The channel estimation device of claim 19, wherein the reference pilot channels and the data resource element are on a same axis of the frequency direction.
